(19) United States
(12) Patent Application Publication
(10) Pub. No.: US 2008/0217842 A1
(43) Pub. Date: Sep. 11, 2008

(54) Substrate Feeding in a Credential Production Device

(75) Inventors: Ted M. Hoffman, Eden Prairie, MN (US); Jeffrey L. Stangler, Eagan, MN (US); John P. Skoglund, Minneapolis, MN (US); Tony Nauth, Bloomington, MN (US)

Correspondence Address: WESTMAN CHAMPLIN & KELLY, P.A., SUITE 1400, 900 SECOND AVENUE SOUTH, MINNEAPOLIS, MN, 55402-3244, US

(73) Assignee: FARGO ELECTRONICS, INC., Eden Prairie, MN (US)

(21) Appl. No.: 11/683,771

(22) Filed: Mar. 8, 2007

(51) Int. Cl. B65H 3/34; G03G 15/22

(52) U.S. Cl. 271/167

(57) ABSTRACT

A method of feeding substrates in a credential production device is provided. A substrate transport has first and second feed rollers displaced along a substrate feed path. A substrate holder containing at least a first substrate engages the first feed roller and a second substrate lies on the first substrate. The first feed roller driven such that the first substrate is fed out of the substrate holder in a forward direction along the substrate feed path. Movement of the second substrate is restricted in the forward direction along the substrate feed path using the first feed roller after the first substrate separates from the first feed roller. The first substrate is fed along the substrate feed path using the second feed roller.

### CROSS-REFERENCE TO RELATED APPLICATIONS

This application incorporates herein by reference in their entirety the following applications filed on even date herewith: U.S. patent application Ser. No. ______ entitled “CARD HOLDER FOR A CREDENTIAL PRODUCTION DEVICE” having inventors Ted M. Hoffman, Jeffrey L. Stangler and John P. Skoglund and attorney docket number F12.12-0165; U.S. patent application Ser. No. ______ entitled “CREDENTIAL PRODUCTION PRINT RIBBON AND TRANSFER RIBBON CARTRIDGES” having inventor Ted M. Hoffman and attorney docket number F12.12-0166; U.S. patent application Ser. No. ______ entitled “PRINTHEAD ASSEMBLY FOR A CREDENTIAL PRODUCTION DEVICE” having inventor Ted M. Hoffman and attorney docket number F12.12-0168; U.S. patent application Ser. No. ______ entitled “CANTILEVERED CREDENTIAL PROCESSING DEVICE COMPONENT” having inventors Ted M. Hoffman and Thomas G. Gale Jr. and attorney docket number F12.12-0169; U.S. patent application Ser. No. ______ entitled “CREDENTIAL PRODUCTION DEVICE HAVING A UNITARY FRAME” having inventors Ted M. Hoffman and James R. Cedar and attorney docket number F12.12-0170; and U.S. patent application Ser. No. ______ entitled “INVERTED REVERSE-IMAGE TRANSFER PRINTING” having inventors Ted M. Hoffman, Jeffrey L. Stangler, John P. Skoglund, Thomas G. Gale Jr. and Tony Nauth and attorney docket number F12.12-0171.

### FIELD OF THE INVENTION

The present invention is generally directed to a credential production device. More particularly, the present invention is directed to feeding substrates in a credential production device.

### BACKGROUND OF THE INVENTION

Credentials include, for example, identification cards, driver's licenses, passports, and other valuable documents. Such credentials are formed from credential substrates including paper substrates, plastic substrates, cards and other materials. Such credentials generally include printed information, such as a photo, account numbers, identification numbers, and other personal information that is printed on the credential substrates using a print consumable, such as ink and ribbon.

Credential production devices process credential substrates by performing at least one step in forming a final credential product. One type of credential production device is a reverse-image credential printing device. Reverse-image credential production devices generally include a printing section and an image transfer section. The printing section utilizes an intermediate transfer film or transfer ribbon, a print ribbon and a printhead. The printhead is typically a thermal printhead that operates to heat different colored dye panels of a thermal print ribbon to transfer the colored dye from the print ribbon to a panel of transfer film to form the image thereon. After the printed image on the transfer film is registered with a substrate, a heated transfer roller of the image transfer section transfers the image from the transfer film or transfer ribbon to a surface of the substrate.

Conventional reverse-image credential printing devices are typically large, cumbersome and complicated machines where improvements to these types of machines are in continuous demand. For example, there is a continuous demand for improving the process by which credential substrates are fed from a substrate holder at a substrate input along a substrate feed path to a substrate output or substrate hopper such that a substrate is not misfed in a credential production device.

Embodiments of the present invention provide solutions to these and other problems, and offer other advantages over the prior art.

### SUMMARY OF THE INVENTION

A method of feeding substrates in a credential production device is provided. A substrate transport has first and second feed rollers displaced along a substrate feed path. A substrate holder containing at least a first substrate engages the first feed roller and a second substrate lies on the first substrate. The first feed roller driven such that the first substrate is fed out of the substrate holder in a forward direction along the substrate feed path. Movement of the second substrate is restricted in the forward direction along the substrate feed path using the first feed roller after the first substrate separates from the first feed roller. Separation of the first substrate from the first feed roller can be sensed. The first substrate is fed along the substrate feed path using the second feed roller.

### BRIEF DESCRIPTION OF THE DRAWINGS

FIG. 1 is an exemplary perspective view of a credential production device under embodiments of the invention.

FIG. 2 is an exemplary exploded perspective view of the credential production device of FIG. 1 under embodiments of the invention.

FIG. 3 is an exemplary simplified schematic diagram of the credential production device illustrated in FIGS. 1 and 2.

FIGS. 4-6 are simplified schematic diagrams of a substrate transport under embodiments of the invention.

FIG. 7 is a flowchart illustrating a method of feeding substrates in a credential production device under embodiments of the invention.

FIG. 8 illustrates a perspective view of a card holder under embodiments of the invention

FIG. 9 illustrates a simplified schematic diagram of the card holder illustrated in FIG. 8.

FIG. 10 illustrates a simplified sectional view of a rotational mechanism or dampener for the card holder of FIG. 8.

FIG. 11 illustrates a perspective view of the card holder illustrated in FIG. 8 with a cover in an open position.

### DETAILED DESCRIPTION OF ILLUSTRATIVE EMBODIMENTS

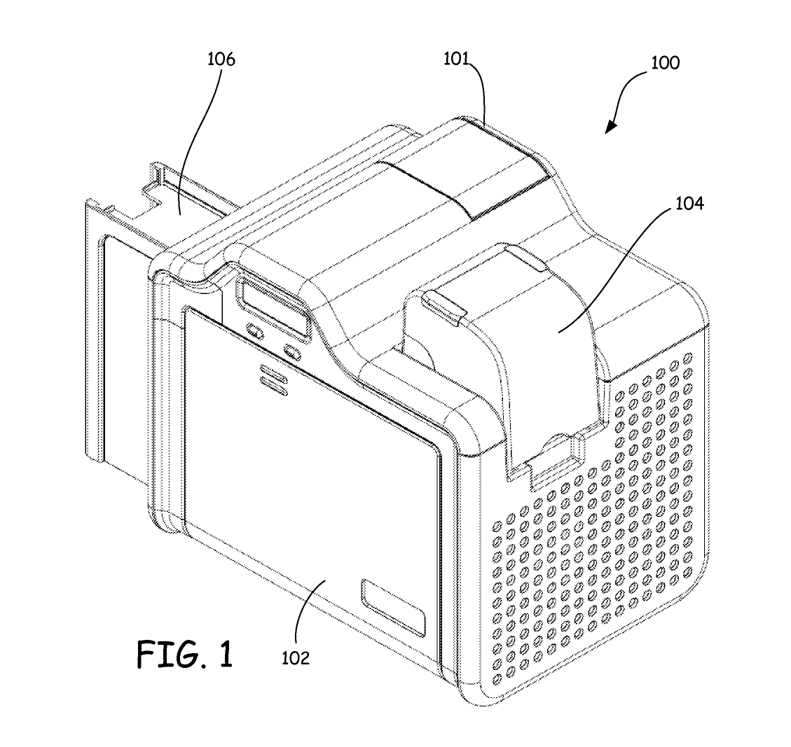

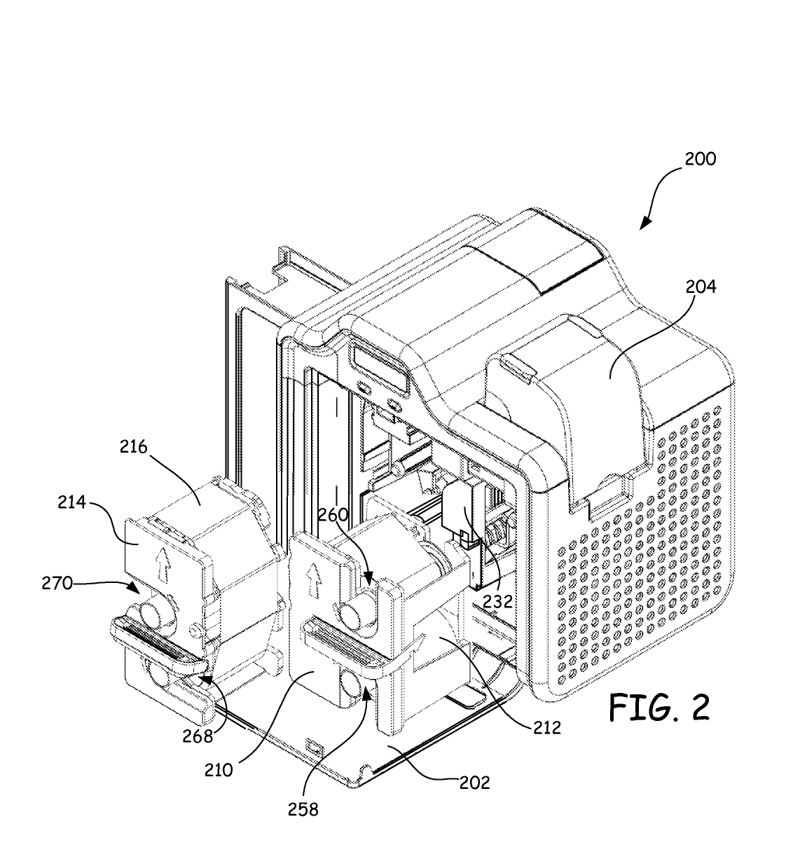

FIGS. 1 and 2 illustrate exemplary perspective views of credential production devices in accordance with embodiments of the invention. FIG. 1 illustrates an exterior view of a credential production device 100. Exemplary credential production device 100 includes an enclosure 101 having a front panel 102. Credential production device 100 utilizes a substrate holder 104, a substrate transport mechanism to transport credential substrates along a substrate feed path to be discharged into a substrate hopper 106. Some embodiments of the disclosure pertain to credential production device 100 as being a reverse-image printer and, therefore, embodiments of the disclosure pertain to the use of credential production device 100 for printing credential substrates to form credentials. However, it should be understood that credential production device 100 can be other types of devices, such as a laminating device, an encoding device or a card flipping device. Device 100 will be described as utilizing credential substrates. In some embodiments, credential substrates are in the form of card substrates for the creation of identification cards. In other embodiments, other types of substrates can be used for forming credentials, such as overlaminate substrates, passport substrates and other valuable substrates.

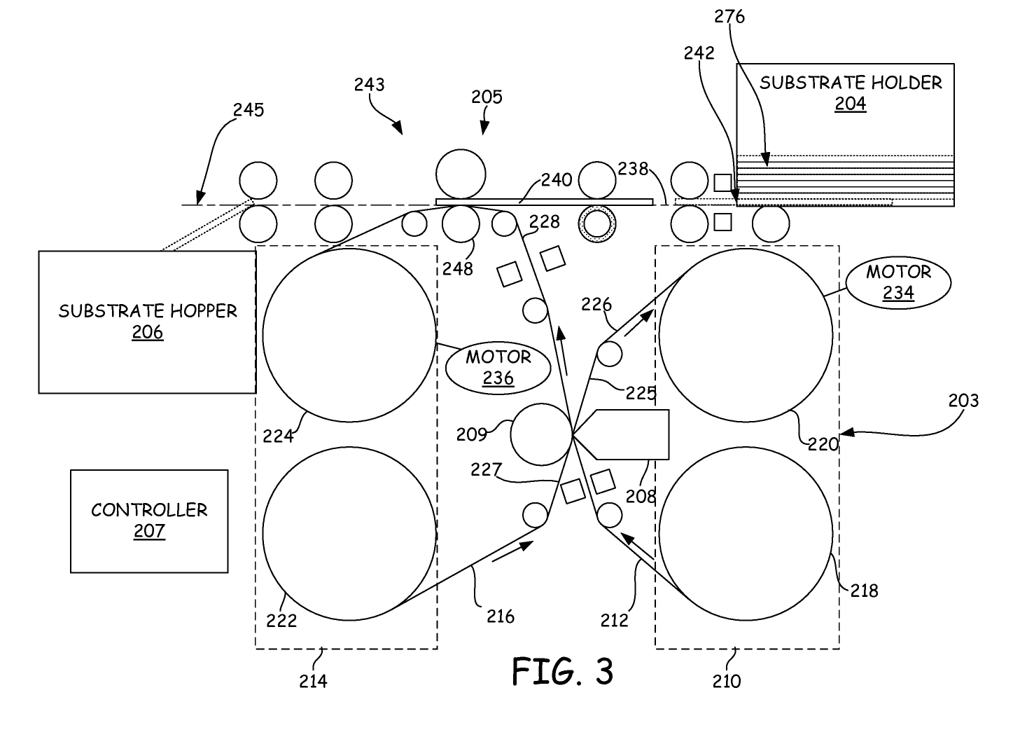

FIG. 2 illustrates an exemplary exploded view of a credential production device 200. Credential production device 200 is an exemplary inverted reverse-image transfer printer as previously discussed as an embodiment of the invention. FIG. 3 illustrates a simplified schematic diagram of exemplary device 200. Credential production device 200 provides inverted reverse-image transfer printing using printing components that are inverted relative to a position of printing components in a conventional reverse-image printing device with respect to a substrate feed path 238 (FIG. 3). Unlike conventional production devices, the inverted nature of credential production device 200 locates production components below its substrate feed path 238. Such a configuration aids in making credential production device 200 more compact, especially in height, allows heat from a transfer roller to dissipate more efficiently and simplifies a substrate feed path of which a credential substrate is transported. Therefore, some embodiments of the disclosure pertain to the use of a substrate holder 204 that contain substrates in credential production device 200. However, it should be understood that embodiments of substrate holder 204 and embodiments of a method of feeding substrates as will be discussed can also be used in other types of credential production devices, such as non-reverse-image credential printing devices, credential laminating devices and credential encoding devices. Before discussing embodiments of the disclosure in detail, components of the embodiment of credential production device 200 providing inverted reverse-image transfer printing will be briefly described.

In FIG. 2, front panel 202 is removed to more clearly illustrate main production components internal to credential production device 200. Credential production device 200 includes a removable print ribbon cartridge 210 and a removable transfer film cartridge 214, both of which are below substrate feed path 238 (FIG. 3). Print ribbon cartridge 210 and transfer ribbon cartridge 214 are releasable and removable from an internal frame 230 of credential production device 200 that is configured to house print ribbon cartridge 210 and transfer ribbon cartridge 214. In FIG. 2, print ribbon cartridge 210 includes a supply spool receiver 258 positioned below a take-up spool receiver 260 and transfer ribbon cartridge 214 includes a supply spool receiver 268 positioned below a take-up spool receiver 270. Supply spool receiver 258 and take-up spool receiver 260 of print ribbon cartridge 210 are configured to receive both ends of a print ribbon 212. Supply spool receiver 268 and take-up spool receiver 270 of transfer ribbon cartridge 214 are configured to receive both ends of a transfer ribbon 216. In other embodiments, the take-up spool receivers in either print ribbon cartridge 210 or transfer ribbon cartridge 214 can be positioned below the supply spool receivers.

When print ribbon cartridge 210 is inserted into credential production device 200, embodiments of print ribbon cartridge 210 also receive a printhead housing 232 contained in internal frame 230. Printhead housing 232 houses a printhead 208 (FIG. 3). In addition, when transfer ribbon cartridge 214 is inserted into credential production device 200, embodiments of transfer ribbon cartridge 214 also receive a transfer roller assembly 247 that includes a transfer roller 248 (FIG. 3).

As illustrated in FIG. 3, credential production device 200 includes a printing section 203 and an image transfer section 205. A controller 207 controls the components of credential production device 200 to perform various operations including substrate feeding, printing an image to a transfer film or ribbon, transferring the image to a substrate, sensor calibration and other operations.

In one embodiment, printing section 203 includes printhead 208, a print platen 209, print ribbon cartridge 210 for supporting a print ribbon 212 and transfer ribbon cartridge 214 for supporting transfer ribbon 216. Print ribbon 212 (e.g., dye sublimation print ribbon) is wound about a supply spool 218 and a take-up spool 220. Supply spool 218 is received by supply spool receiver 258 (FIG. 2) and take-up spool 220 is received by take-up spool receiver 260 (FIG. 2). Transfer ribbon 216 is wound about a supply spool 222 and a take-up spool 224. Supply spool 222 is received by supply spool receiver 268 (FIG. 2) and take-up spool 224 is received by take-up spool receiver 270 (FIG. 2). Print ribbon 212 includes a first surface 225 and a second surface 226 opposite the first surface. When print ribbon 212 is wound about spools 218 and 220, first surface 225 faces the interior of print ribbon cartridge 210 and second surface 226 faces transfer ribbon cartridge 214. Transfer ribbon 216 includes a first surface 227 and a second surface 228 opposite the first surface. When transfer ribbon 216 is wound about spools 222 and 224, first surface 227 faces the interior of transfer ribbon cartridge 214 and second surface 228 faces print ribbon cartridge 210.

Print ribbon 212 and transfer ribbon 216 are fed between printhead 208 and platen 209. Printhead 208 is positioned within printhead housing 232 (FIG. 2) and allowed to rotate about a rotation path such that heating elements face and apply pressure on print platen 209 and therefore places second surface 226 of print ribbon 212 in contact with second surface 228 of transfer ribbon 216. Print ribbon 212 extends between second surface 228 of transfer ribbon 216 and printhead 208.

Credential production device 200 includes motors 234 and 236 for operating the movement of print ribbon 212 and transfer ribbon 216, respectively. Printhead 208 applies pressure against print platen 209 such that printhead 208 is in contact with first side 225 of print ribbon 212 and brings print ribbon 212 in contact with second side 228 of transfer ribbon 216. In one embodiment, printhead 208 is a thermal printhead having a plurality of burn or heating elements. The burn elements on printhead 208 transfer a reverse-image onto a panel of transfer ribbon 216 using print ribbon 212. Printhead 208 prints each panel of transfer ribbon 216 while oriented approximately perpendicularly to substrate feed path 238 and positioned below substrate feed path 238. The reverse-image on the panel of transfer ribbon 216 is then moved towards feed path 238 for transferring the reverse-image to a credential substrate 240.

In another exemplary embodiment, image transfer section 205 includes a substrate input 242, a substrate transport 243, and a substrate output 245. Credential substrate 240 is received by substrate transport 243 from substrate holder 204 that includes a stack of credential substrates 276 at substrate input 242. Controller 207 controls substrate transport 243 to feed individual credential substrates 240 along substrate feed path 238 from a bottom of the stack of credential substrates. In one embodiment, processing path 238 is substantially flat between substrate input 242 and substrate output 245 to avoid any bending or damaging of substrates 240, particularly when they are in the form of rigid or semi-rigid plastic card substrates used to form identification cards. At substrate output 245, credential substrate 240 is discharged into substrate hopper 206. Along with components located below substrate feed path 238 for transferring an image to credential substrate 240, substrate hopper 206 and substrate output 245 are also positioned below substrate feed path 238. Credential substrate 240, when discharged through substrate output 245 falls into substrate hopper 206. Unlike conventional reverse-image production devices, such configurations aid in making credential production device 200 more compact, especially in height, allows heat from transfer roller 248 to dissipate more efficiently and simplifies substrate feed path 238 of which credential substrate 240 is transported.

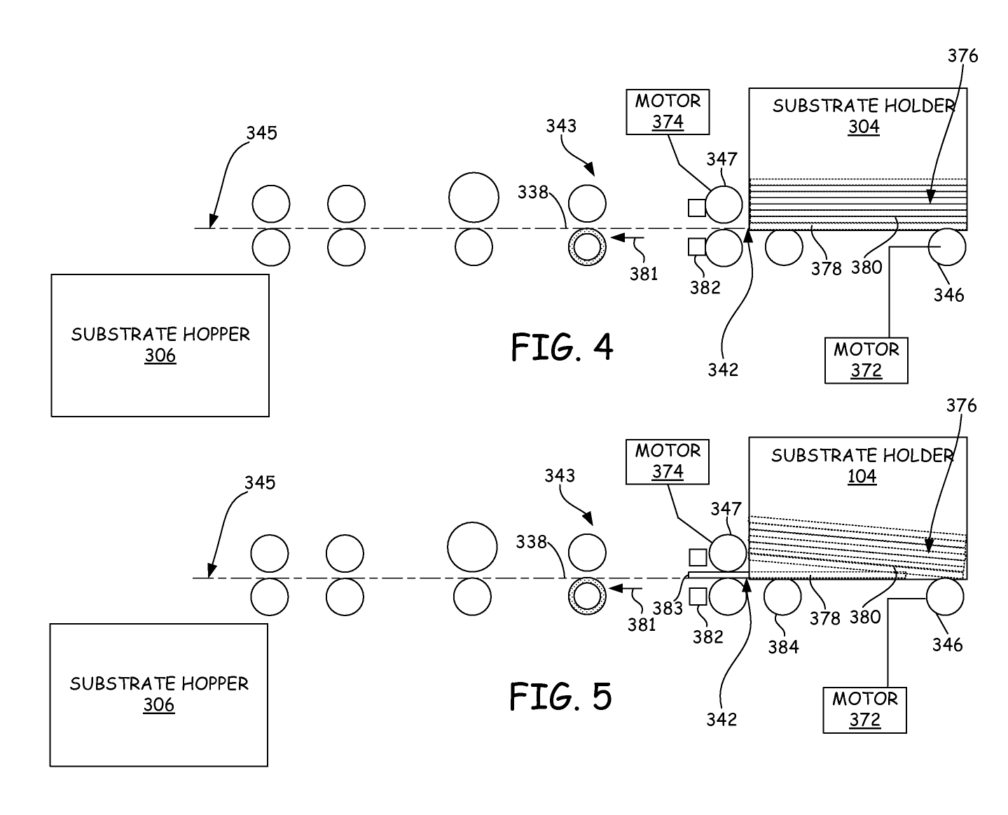

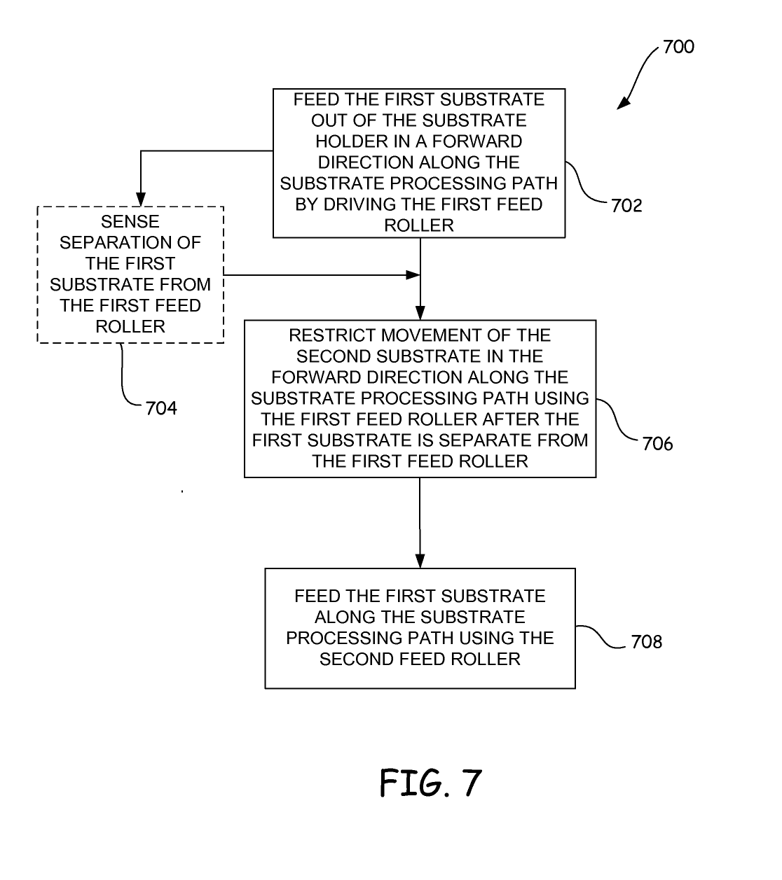

FIGS. 4, 5 and 6 are detailed diagrammatic illustrations of the transport of substrates using substrate transport 343 in a credential production device. FIG. 7 is a flowchart illustrating a method of feeding credential substrates in a credential production device, such as credential production devices 100 and 200. The following description utilizes FIGS. 4-7 to describe the method of feeding credential substrates in a credential production device.

In FIGS. 4, 5 and 6, substrate transport 343 includes a first substrate feed roller 346 and a second substrate feed roller 347 displaced along a substrate feed path 338. First substrate feed roller 346 is located below substrate holder 304. Second substrate feed roller 347 is located proximate to substrate input 342 and between a substrate hopper 306 and a substrate holder 304 along substrate feed path 338. Substrate rollers 346 and 347 are driven by motors through gear and pulley arrangements or other configurations. In the embodiments illustrated in FIGS. 4, 5 and 6, separate motors are used for each feed roller 346 and 347. For example, a first motor 372 can be used to drive first feed roller 346 and a second motor 374 can be used to drive second substrate roller 347. As previously mentioned, substrate holder 304 includes a stack of credential substrates 376. At any given moment and as clearly shown in FIG. 4, stack of substrates 376 positioned in substrate holder 304 includes a bottom credential substrate or first credential substrate 378 and includes a second credential substrate 380 that lies on top of first credential substrate 378.

To feed substrates from stack of substrates 376, first substrate 378 is fed out of substrate holder 304 in a forward direction 381 along substrate feed path 338 using first feed roller 346 driven by first motor 372. Such a step is illustrated in block 702 of FIG. 7. As illustrated in FIG. 4, first feed roller 346 engages first credential substrate 378 to feed first substrate 378 out of substrate holder 304. Substrate holder 304 includes a flexible gate (not shown in FIGS. 4-6). First feed roller 346 feeds first substrate 378 out of substrate holder 304 and through the flexible gate.

In FIG. 7, the method of feeding substrates in a credential production device optionally includes the step of sensing the separation of first substrate 378 from first feed roller 346 as illustrated in dashed block 704. In one embodiment, a sensor 382 senses the presence of first substrate 378 at a certain location along feed path 338 that indicates that first substrate 378 has separated from first feed roller 346. For example, sensor 382 can sense the presence of a leading edge end 383 of first substrate 378 that is outside substrate holder 304 at a given distance. Such a sensed positioned is illustrated in FIG. 5.

At block 706, first feed roller 346 restricts movement of second substrate 380 in forward direction 381 along substrate feed path 338 after first feed roller 346 is disengaged from first substrate 378. As diagrammatically illustrated in FIG. 5, the step in block 706 of FIG. 7 can be accomplished by deactivating first motor 372. The step illustrated in block 704 can also be accomplished by deactivating first motor 372 and braking first feed roller 346. At block 708, first substrate 378 is fed along feed path 338 using second feed roller 347 after first substrate 378 is disengaged from first feed roller 346.

Referring to FIG. 5, substrate transport 343 also includes a third feed roller 384. Third feed roller 384 is configured to support first substrate 378 on second feed roller 347 during the step of feeding the first substrate along feed path 338 using second feed roller 347 as illustrated in block 708. After second feed roller 347 disengages from first substrate 378, first feed roller 346 can drive second substrate 380 out of substrate holder 304 in forward direction 381 along feed path 338 such that second substrate 380 can be fed along feed path 338 using second feed roller 347.

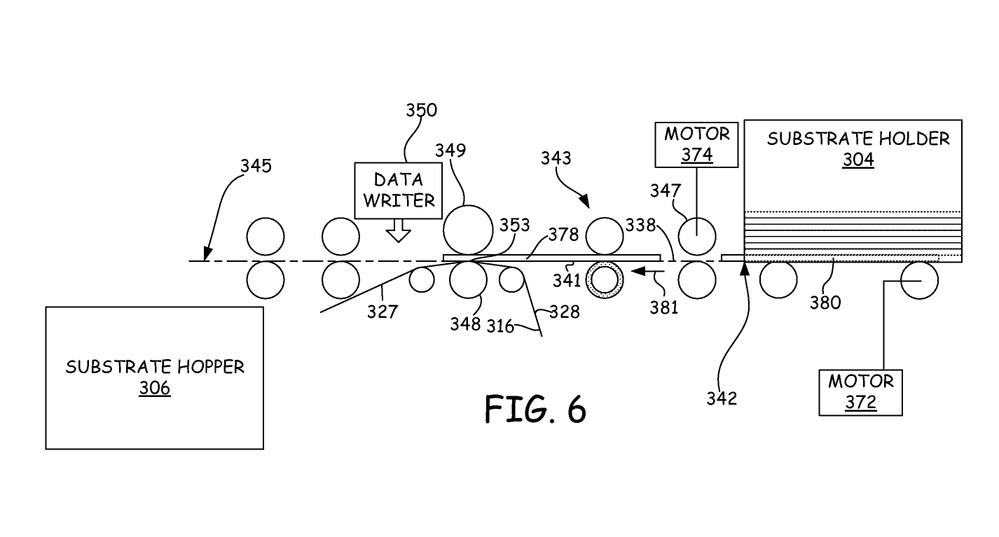

Following the step of feeding first substrate 378 along feed path 338 using second feed roller 347, a process is performed on first substrate 378. Such a process can include printing an image on a bottom surface 341 (FIG. 6) of first substrate 378, laminating an overlaminate to first substrate 378, encoding data to first substrate 378 and laminating first substrate 378 to a card substrate.

For example, FIG. 6 illustrates a transfer roller 348 positioned below processing path 338. Transfer roller 348 positions transfer ribbon 316 that includes an image adjacent feed path 338. During processing, transfer roller 348 transfers an image from transfer ribbon 316 to a bottom surface 341 of first substrate 378 as first substrate 378 moves along feed path 338. A first surface 327 of transfer ribbon 316 engages a top surface 353 of transfer roller 348, while second surface 328 of transfer ribbon 316 faces feed path 338. Transfer roller 348 presses transfer ribbon 316 and substrate 378 against a platen 349 such that a reverse-image printed on transfer ribbon 316 is transferred onto bottom surface 341 of first substrate 378. Transfer roller 348 uses heat and pressure to transfer the reverse-image printed on transfer ribbon 316 onto substrate 378.

In another example, a data writer 350 is also illustrated in FIG. 6. Data writer 150 is positioned between transfer roller 348 and substrate output 345 along feed path 338. While FIG. 6 illustrates data writer 350 positioned above feed path 338, it can also be positioned below feed path 338. Data writer 350 is configured to encode substrate 378 with data. In one embodiment, data writer 350 can write data to a magnetic stripe of substrate 378. In another embodiment, data writer 350 can write data to a memory of substrate 378. In yet another embodiment, a data reader can also be included that is configured to read data written to a magnetic stripe or memory of a substrate. After a process is performed on first substrate 378, first substrate 378 exits feed path 338 at output 345 and is retained by substrate hopper 306. Then, a similar process is performed on second substrate 380.

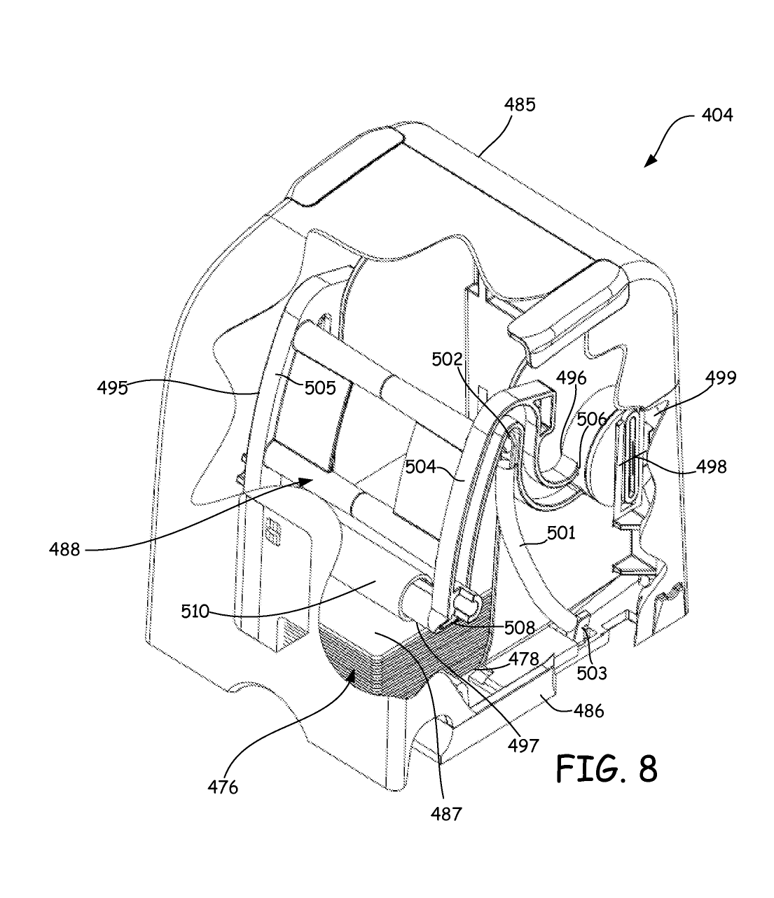

In some embodiments, substrate holders 106, 206 and 306, previously discussed, can be a card holder for holding identification card substrates. FIG. 8 illustrates a perspective view of such a card holder 404 in accordance with embodiments of the invention. Card holder 404, illustrated in FIG. 8, is removed from a credential production device for illustrative purposes, but is shown coupled to a credential production device in FIG. 1 and exploded from a credential production device in FIG. 2. Card holder 404 includes a housing 485 having a base 486. A stack of cards 476 are supported above base 486 and includes a top card 487 that is displaced a greater distance from base 486 than a bottom card 478 of stack of cards 476. Card holder 404 includes a card press 488. Card press 488 is configured to apply a load to top card 487.

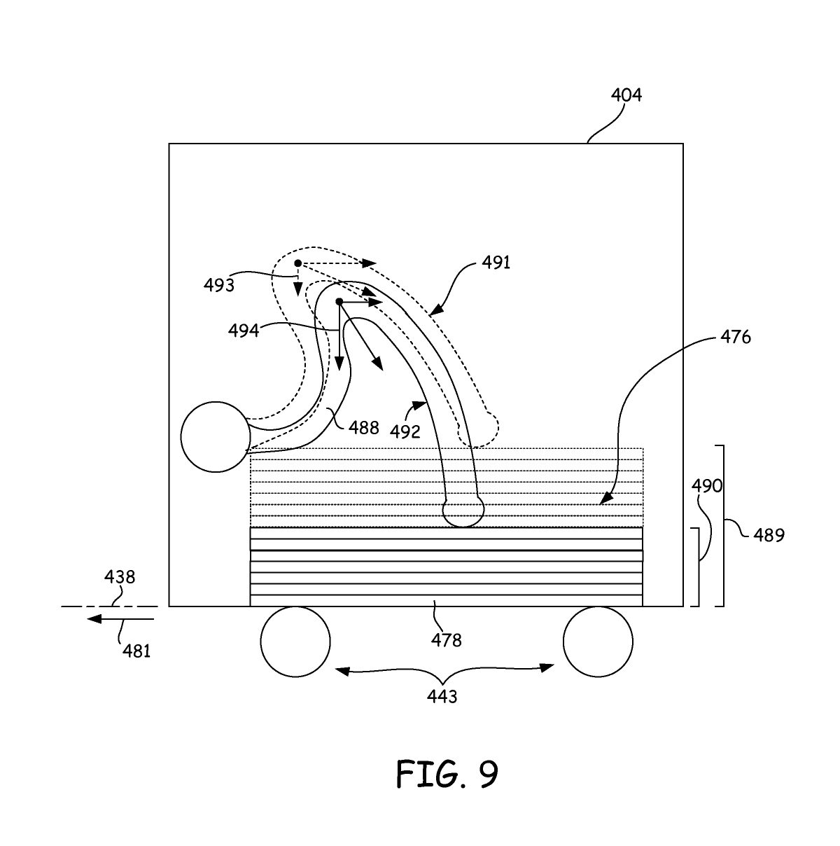

FIG. 9 illustrates a schematic diagram of card holder 404 as it interacts with a card substrate transport 443 in accordance with embodiments of the invention. Card substrate transport 443 is configured to feed bottom card 478 from stack of card substrates 476 along a card feed path 438 in a forward direction 481. FIG. 9 illustrates a first amount 489 of card substrates and a second amount 490 of card substrates in card stack 476. First amount 489 of card substrates is greater than second amount 490 of card substrates. Therefore, first amount 489 of card substrates has a height that is greater than second amount 490 of card substrates, or rather, first amount 489 of card substrates has a thickness that is greater than a thickness of second amount 490 of card substrates.

FIG. 9 illustrates card press 488 at a first position 491 when card stack 476 has first amount 489 of card substrates. FIG. 9 also illustrates card press 488 at a second position 492 when card stack 476 has a second amount 490 of card substrates. At first position 491, card press 488 includes a perpendicular load component 493. At second position 492, card press 488 includes a perpendicular load component 494. As illustrated in FIG. 9, a magnitude of perpendicular load component 493 of first position 491 is less than a magnitude of perpendicular load component 494 of second position 492. Therefore, as the thickness of card stack 476 or the amount of card substrates in card stack 476 decreases, the magnitude of the perpendicular load component of card press 488 increases. In other words, a direction of a resultant load component (illustrated in FIG. 9) moves perpendicularly to base 486 as the thickness of stack of cards 476 decreases.

With reference back to FIG. 8 and in one embodiment, card press 488 includes an arm 495 coupled to a rotational mechanism 499. Arm 495 includes a first end 496 and a second end 497. First end 496 is configured to pivot about an axis 498. Rotational mechanism 499 provides axis 498. A portion of rotational mechanism 499 is configured to be fixed to housing 485 of card holder 404, while a remaining portion of rotational mechanism 499 is configured to rotate about axis 498. Rotational mechanism 499 will be discussed in more detail below. The perpendicular load component, such as perpendicular load component 493 or perpendicular load component 494, applied by card press 488 on card stack 476 is applied to top card 487 through second end 497 of arm 495. Second end 497 of arm 495 applies the perpendicular load component substantially uniformly across a width of top card 487.

In one embodiment, card press 488 can include a first arm component 504 and a second arm component 505. First arm component 504 includes a first end 506 that is configured to pivot about axis 498 and second arm component 505 includes a first end (hidden from view in FIG. 8) that is configured to pivot about axis 498. First arm component 504 includes a second end 508 and second arm component 505 includes a second end (hidden from view in FIG. 8).

In one embodiment, card press 488 includes a spring member 501. Spring member 501 includes a first end 502 and a second end 503. First end 502 of spring member 501 is coupled to arm 495 of card press. Second end 503 of spring member 501 is coupled to housing 485 of card holder 404. In particular, second end 503 of spring member 501 is coupled to base 486. Spring member 501 is configured to provide card press 488 with a load. The load applied by card press 488 is applied uniformly across width 500 of card stack 476. In particular, the load force supplied by spring member 501 is applied to top card 487 through second ends 508 and 509. Extending between second ends 508 and 509 of first arm 504 and second arm 505 and across width 500 of top card 487 includes a bar member 510. In this embodiment, the load force supplied by spring member 501 is applied through bar member 510.

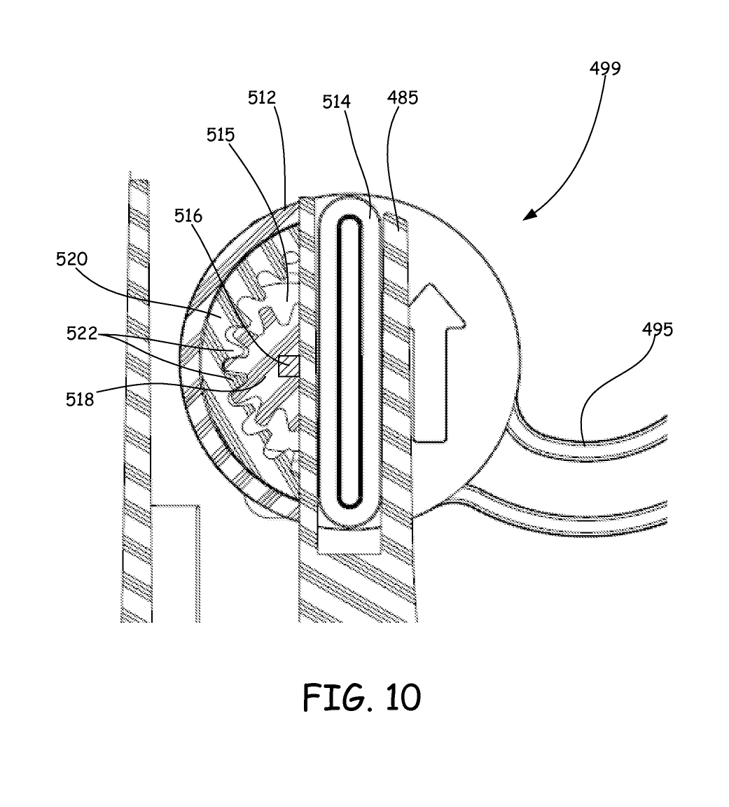

FIG. 10 illustrates an enlarged sectional view of rotational mechanism 499 in accordance with an embodiment of the invention. Rotational mechanism or dampener 499 provides frictional resistance to movement of first end 496 of arm 495. In one embodiment, rotational mechanism 499 includes a first portion 512. First portion 512 is integrally formed with arm 495. FIG. 10 also illustrates second portion 514 of rotational mechanism 499. Second portion 514 is configured to mate with first portion 512. Second portion 514 is rotationally fixed to housing 485 of card holder 404, while first portion 512 is configured to rotate while engaged with second portion 514.

First portion 512 includes a shaft 516 and an internal planet gear 518 having gear teeth. Outer ring gear 520 supports first portion 512 and rotatably couples first portion to housing 485 (FIG. 8) of card holder 404 (FIG. 8). Shaft 516 is positioned at the center of internal planet gear. It should be noted that first portion 512, shaft 516 and internal planet gear 518 are all integrally formed with arm 495. Second portion 514 is an outer ring gear 520 having gear teeth 522. In operation, internal planet gear 518 follows along gear teeth 522 of outer ring gear 520 upon an external input that forces arm 495 to move. The interconnection of the gear teeth of internal planet gear 518 and gear teeth 522 of outer ring gear 520 provides a frictional resistance to movement which is applied to arm 495.

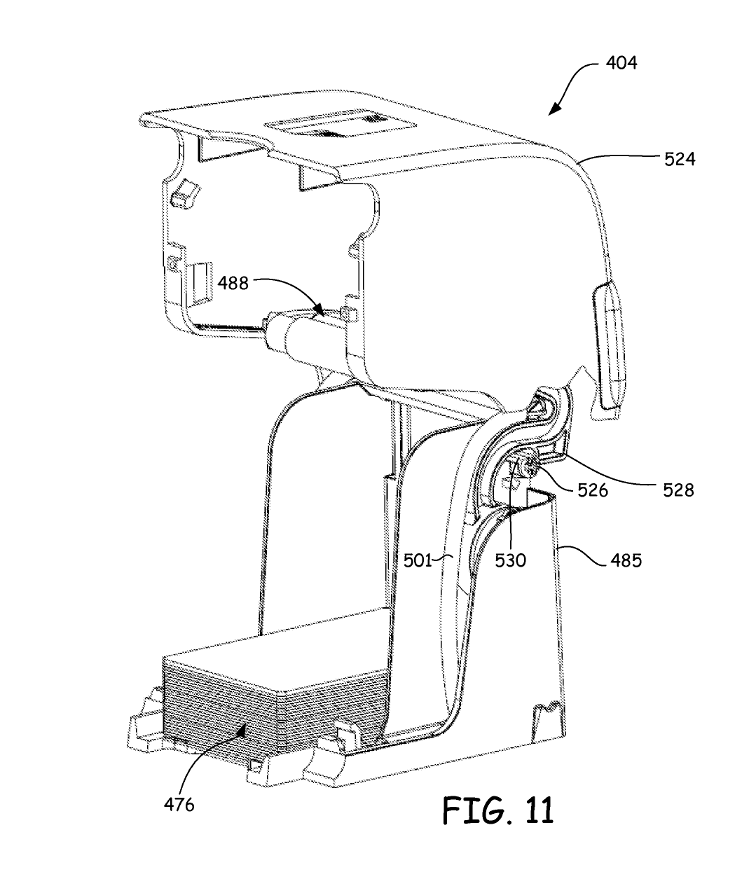

FIG. 11 illustrates a perspective view of housing 485 of card holder 404. FIG. 11 illustrates that housing 485 includes a cover 524 that is rotatable about an axis 526. Cover 524 pivots about axis 526 between an open position (illustrated in FIG. 11) and a closed position (illustrated in FIG. 8). By rotating cover 524 about axis 526, stack of card substrates 476 can be easily loaded into card holder 404. To prevent spring member 501 from biasing cover 524 into a closed position by card press 488 with a load, card press 488 includes a wing structure 528 that is integrally formed with arm 488. Wing structure 528 is configured to be positioned around axis 526 that includes a bar 530 to hold card press 488 in place. Therefore, the load supplied by spring member 501 is removed from top card 487 when cover 524 is moved into an open position (as illustrated in FIG. 11) and the load supplied by spring member 501 is applied to top card 487 when cover 524 is in a closed position (as illustrated in FIG. 8).

Although the present invention has been described with reference to preferred embodiments, workers skilled in the art will recognize that changes may be made in form and detail without departing from the spirit and scope of the invention.

What is claimed is:

1. A method of feeding substrates in a credential production device including a substrate transport having first and second feed rollers displaced along a substrate feed path and a substrate holder containing at least a first substrate engaging the first feed roller and a second substrate lying on the first substrate, the method comprising steps of:
driving the first feed roller and feeding the first substrate out of the substrate holder in a forward direction along the substrate feed path;
restricting movement of the second substrate in the forward direction along the substrate feed path using the first feed roller after the first substrate separates from the first feed roller; and
feeding the first substrate along the substrate feed path using the second feed roller.

2. The method of claim 1, wherein the restricting step includes braking the first feed roller.

3. The method of claim 1, wherein the restricting step includes deactivating the driving of the first feed roller.

4. The method of claim 1, further comprising sensing separation of the first substrate from the first feed roller prior to the restricting step.

5. The method of claim 4, wherein the sensing step includes sensing the presence of the first substrate at a location along the substrate feed path that indicates that the first substrate has separated from the first feed roller.

6. The method of claim 5, wherein the sensing step includes sensing the presence of a leading edge of the first substrate that is outside of the substrate holder.

7. The method of claim 1, further comprising providing a third feed roller between the first and second feed rollers to support the first substrate on the second feed roller during the step of feeding the first substrate along the substrate feed path using the second feed roller.

8. The method of claim 1, wherein the first and second substrates comprise card substrates.

9. The method of claim 1, wherein the first and second substrates comprise overlaminate substrates.

10. The method of claim 1, further comprising performing a process on the first substrate following the step of feeding the first substrate along the substrate feed path using the second feed roller selected from the group consisting of printing an image on the first substrate, laminating an overlaminate to the first substrate, encoding data to the first substrate, and laminating the first substrate to a card substrate.

11. A method of feeding substrates in a credential production device including a substrate transport having first and second feed rollers displaced along a substrate feed path and a substrate holder containing at least a first substrate engaging the first feed roller and a second substrate lying on the first substrate, the method comprising steps of:
feeding the first substrate out of the substrate holder in a forward direction along the substrate feed path using the first feed roller;
sensing separation of the first substrate from the first feed roller;
restricting movement of the second substrate in the forward direction along the substrate feed path using the first feed roller when the separation of the first substrate from the first feed roller is sensed; and
feeding the first substrate along the substrate feed path using the second feed roller.

12. The method of claim 11, wherein the restricting step includes braking the first feed roller.

13. The method of claim 11, wherein the restricting step includes deactivating the driving of the first feed roller.

14. The method of claim 11, wherein the sensing step includes sensing the presence of the first substrate at a location along the substrate feed path that indicates that the first substrate has separated from the first feed roller.

15. The method of claim 14, wherein the sensing step includes sensing the presence of a leading edge of the first substrate that is outside of the substrate holder.

16. The method of claim 11, wherein the feeding the first substrate out of the substrate holder includes feeding the first substrate through a flexible gate of the substrate holder.

17. The method of claim 11, further comprising providing a third feed roller between the first and second feed rollers to support the first substrate on the second feed roller during the step of feeding the first substrate along the substrate feed path using the second feed roller.

18. The method of claim 11, wherein the first and second substrates comprise card substrates.

19. The method of claim 11, wherein the first and second substrates comprise overlaminate substrates.

20. The method of claim 11, further comprising performing a process on the first substrate following feeding the first substrate along the substrate feed path using the second feed roller selected from the group consisting of printing an image on the first substrate, laminating an overlaminate to the first substrate, encoding data to the first substrate, and laminating the first substrate to a card substrate.
